(19) United States
(12) Patent Application Publication
(10) Pub. No.: US 2007/0084487 A1
(43) Pub. Date: Apr. 19, 2007

(54) Surface cleaning device

(75) Inventors: Jorg Hoffmann, Hasbergen (DE); Werner Trentmann, Ostercappeln (DE); Christian Duker, Elsten (DE); Bernhard Sievering, Emsburen (DE)

Correspondence Address: GUDRUN E. HUCKETT DRAUDT, LONSSTR. 59, WUPPERTAL, 42289, DE

(73) Assignee: BVL OBERFLACHENTECHNIK GMBH, Emsburen (DE)

(21) Appl. No.: 11/548,747

(22) Filed: Oct. 12, 2006

(30) Foreign Application Priority Data
Oct. 13, 2005 (DE) 10 2005 049 473.0

(51) Int. Cl. B08B 3/00; B08B 3/12

(52) U.S. Cl. 134/56 R; 134/184; 134/109

(57) ABSTRACT

A surface cleaning device has a cleaning chamber for goods to be cleaned with a cleaning medium. At least one tank for the cleaning medium is provided. A cleaning medium circuit is provided that has a supply device that conveys the cleaning medium from the at least one tank to the cleaning chamber and a return device that returns the cleaning medium from the cleaning chamber to the at least one tank. An analytical device for measuring contamination of the cleaning medium is provided.

### BACKGROUND OF THE INVENTION

The invention relates to a surface cleaning device comprising a cleaning chamber, designed for receiving goods to be cleaned by means of a cleaning medium, as well as at least one tank from which the cleaning medium can be introduced into the cleaning chamber by means of a supply device and into which the cleaning medium can be returned by means of a return device after the cleaning process.

In many industrial facilities, different industrial goods must be cleaned daily to remove oil, grease or other contaminants, for example, for pretreating for subsequently painting sheet metal, for intermediate cleaning within a manufacturing line for transmissions, or, in the field of repair work, for final cleaning before installing the repaired parts. Depending on the type of use of the individual industrial goods to be cleaned, the requirements that are to be fulfilled in regard to surface cleanliness of the industrial goods are different.

For cleaning industrial goods, usually surface cleaning devices are used in which by means of a cleaning medium, for example, a washing liquid, the component to be cleaned is washed. Even though the cleaning medium is optionally passed through filter systems after the washing process, the cleaning medium will be contaminated over time and must be changed. Changing the cleaning medium of the surface cleaning device induces high costs so that it is desirable to change the cleaning medium only once the cleanliness of the surface can no longer be ensured for industrial goods to be subsequently cleaned. The change of the cleaning medium is initiated, for example, after visual control of the cleaning medium or the industrial goods to be cleaned; this is a cumbersome and a time-consuming operation. In particular, changing of the cleaning medium performed too early or too late causes environmental impact, high costs and an increased disposal expenditure for the cleaning medium.

### SUMMARY OF THE INVENTION

It is therefore an object of the present invention to provide a surface cleaning device whose manipulation with regard to changing of the cleaning medium is improved.

In accordance with the present invention, this is achieved in that an analytical device for measuring the contamination of the cleaning medium is provided.

By means of the analytical device monitoring of the contamination of the cleaning medium in operation can be carried out. The personnel operating the surface cleaning device receive by means of the analytical device representative information in regard to the cleanliness of the cleaning medium and can perform, as a function of the purity requirements regarding the surface of the industrial goods, the change of the cleaning medium in a timely fashion.

Advantageously, the analytical device is connectable by a bypass to the cleaning medium circuit of the surface cleaning device. As a cleaning medium preferably washing solutions or other fluids are to be used so that the surface cleaning device has a plurality of pipes or other conduits to which the analytical device can be flanged in a simple way. The circuit proper of the cleaning medium is therefore not impaired by the additional connection of the analytical device because only minimum amounts of the cleaning medium are required for measuring its contamination. Alternatively, according to another embodiment of the invention, the analytical device can be integrated so completely into the circuit that, for example, the entire cleaning medium can be monitored along its path into the cleaning chamber.

The cleaning medium is usually supplied from the tank of the surface cleaning device into the cleaning chamber by means of a supply device. In the cleaning chamber, the industrial goods, depending on the configuration of the surface cleaning device, are cleaned in different ways. For example, the supply device has a rotatable spraying frame provided with spray nozzles; the spraying frame can rotate about a basket that is loaded with the goods to be cleaned and introduced into the cleaning chamber. Alternatively, the nozzles can be fixedly installed on the frame or integrated into the walls of the cleaning chamber while the basket is arranged on a rotary table.

The cleaning medium that is contaminated during the cleaning process by taking up oil or grease is returned exclusively by means of the return device and optionally provided cleaning systems into the tank. For example, it is possible to provide between the cleaning chamber and the tank a plate-type phase separator for cleaning the contaminated cleaning medium. Also, collecting areas can be provided in the cleaning chamber or in the tank for gravitational deposition of dirt particles contained in the cleaning medium. Advantageously, the analytical device can still be connected either to the return device or directly to the tank.

For measuring the contamination of the cleaning medium there are a plurality of known methods that have different analytical focus. Based on the simplicity of the configuration and the cost-efficient components, it has been found to be particularly advantageous to configure the analytical device for measuring the turbidity of the cleaning medium. Such a measurement of optically visible contaminants is already sufficient for a plurality of industrial applications. Only in the case of very high purity requirements, for example, contamination of the cleaning medium with minimal invisible concentrations of oil, it is necessary to carry out, for example, a spectral analysis of the cleaning medium in addition or as a supplement to a purely brightness-based measurement. For this purpose, the analytical device must then be configured appropriately.

### BRIEF DESCRIPTION OF THE DRAWING

FIG. 1 shows the cleaning device according to the invention in a schematic illustration.

FIG. 2 shows the detail II of FIG. 1.

### DESCRIPTION OF THE PREFERRED EMBODIMENTS

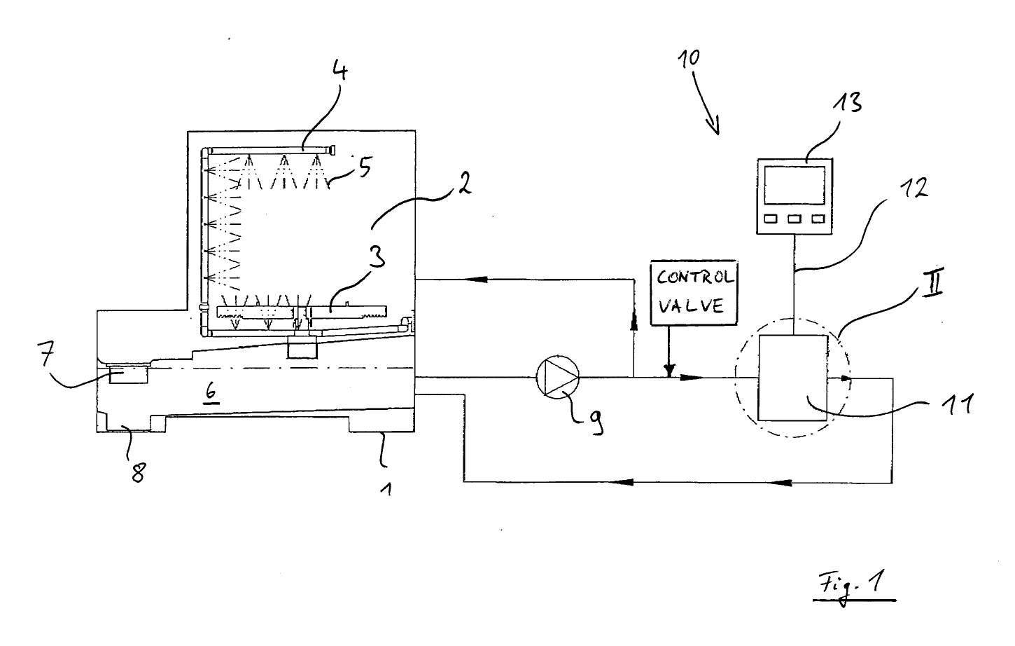

FIG. 1 shows a cleaning chamber 2 arranged in housing 1 whose walls in the schematic illustration are formed by the housing wall. The cleaning chamber 2 is provided with an opening (not illustrated) that can be closed and through which the industrial goods to be cleaned are placed into the rotary assembly 3. When the door of the opening is closed, the spray nozzles arranged on the spraying frame 4 will automatically begin to spray the cleaning medium 5 onto the industrial goods to be cleaned while the rotary assembly 3 with the industrial goods will rotate.

By means of a pump unit 9 of the supply device, the cleaning medium 5 is conveyed from the tank 6 in the direction toward the cleaning chamber 2. Between cleaning chamber 2 and pump unit 9 a branch or bypass is provided through which a measuring device 11 of an analytical device 10 is supplied with a portion of the cleaning medium 5. The supply of cleaning medium 5 can be controlled, for example, by means of a control valve. The cleaning medium 5 used for turbidity measurement is returned from this measuring device 11 to the tank 6.

The contaminated cleaning medium 5 collects at the bottom of the cleaning chamber 2 and is guided by the slanted bottom to a filter unit 7 that forms the transition to the tank 6. The filter unit 7 forms in this connection the return device.

The tank 6 itself has, in turn, a collecting area 8 in which dirt particles that are not filtered out by the filter can deposit. This collecting area must be emptied from time to time.

The measuring device 11 is controlled by means of a signal line 12; on the other hand, by means the signal line or date line 12 the transmission of measured values to the evaluation device 13 is carried out also. The evaluation device 13, in turn, can be in the form of a computer provided with an appropriate software. A continuous measurement of the cleaning medium 5 is possible.

The measuring device 11 and the evaluation device 13 can be arranged in a single housing. However, it is possible to provide two different devices that are connected by the signal line 12 with one another.

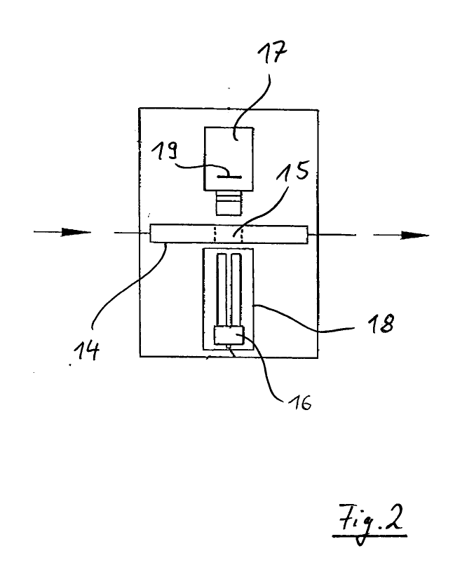

In FIG. 2 the configuration of the measuring device 12 is illustrated in more detail. The cleaning medium 5 is passed through the measuring device and flows, for example, through a glass tube 14 that forms a flow passage 15. This flow passage 15 is located between a light source 16 and a measuring unit 17 that is in the form of a camera in the illustrated embodiment. The light source 16 is a white light source, for example, a commercially available incandescent light bulb whose light is guided by means of an aperture device 18 in the direction of the flow passage 15. As a result of contamination or soiling of the cleaning medium, only a portion of the light will reach the measuring unit 17 and will be registered or recorded thereat by the area sensor 19. The area sensor 19, for example, a CMOS (complementary metal oxide semiconductor) sensor, records for each measurement across its entire surface area brightness values and therefore provides a plurality of measured values that, when averaged, provide a mean gray value. Averaging can be carried out by means of the measuring unit 17 itself or the evaluation device 13.

As a result of the flat configuration and the large number of measured values of the area sensor, across a large area of the cleaning medium 5 a value is determined that averages already for many contaminants such as schlieren or cloudiness in the cleaning medium 5 and therefore provides an excellent value for contamination of the medium 5. This value will be recalculated into a contamination value, based on calibration data stored in a storage unit (software or hardware) of the evaluation device, and will be displayed on a display and saved, for example.

A measure for the concentration (contamination or soiling) of the cleaning medium 5 can be calculated based on impinging and transmitted intensity, for example, by using the mean gray value of all pixels and employing the Beer-Lambert Law. The required parameters are either input beforehand or preset by means of calibration. Even though the Beer-Lambert Law can be applied usually only for monochromatic radiation and diluted solutions, it has been found that based on such an evaluation at least visually detectable contaminations that are present in a plurality of fields of application can be detected very well. The surface cleaning device according to the invention provided with the analytical device 10 can therefore indicate in a simple and inexpensive way the contamination of the cleaning medium 5. The cleaning medium 5 can therefore be changed at the right time.

A camera that is furnished with a commercially available CMOS sensor carries out several dozen measurements per second; this leads to continuous monitoring of the cleaning medium.

As an alternative to the commercially available white light source, it is also possible to employ a laser whose light is recorded by a receiver that is matched to the wavelength of the laser. The use of a commercially available incandescent light bulb with a commercially available camera provides an inexpensive analytical device 10 that provides an excellent image of the turbidity that occurs in industrial washing operations.

In addition to the afore described measuring device, it is possible to design such a measuring device in a different configuration in accordance with the present invention. For example, simple brightness-sensitive photo transistors or wave-length sensitive measuring elements can be used that are matched to the emission wavelengths of the light source in order to obtain additional information in regard to the contamination of the cleaning medium 5.

It is moreover advantageous to combine the control of the surface cleaning device with the analytical device 10 so that, for example, upon surpassing a predetermined level of contamination, the surface cleaning device stops its operation in order to change the cleaning medium 5. The change of the cleaning medium 5 can be carried out fully automatically so that no additional operating personnel is required for changing the cleaning medium.

The surface cleaning device can be designed such that fluorescent goods are cleaned. The analytical device is then adapted for evaluating fluorescent goods. A device for illuminating the fluorescent goods is then provided.

The specification incorporates by reference the entire disclosure of German priority document 10 2005 049 473.0 having a filing date of Oct. 13, 2005.

While specific embodiments of the invention have been shown and described in detail to illustrate the inventive principles, it will be understood that the invention may be embodied otherwise without departing from such principles.

What is claimed is:

1. A surface cleaning device comprising:
a cleaning chamber adapted to receive goods to be cleaned;
at least one tank for receiving a cleaning medium;
a cleaning medium circuit comprising a supply device that conveys the cleaning medium from the at least one tank to the cleaning chamber and a return device returning the cleaning medium from the cleaning chamber to the at least one tank;
an analytical device for measuring contamination of the cleaning medium.

2. The surface cleaning device according to claim 1, wherein the analytical device is connected by a bypass to the cleaning medium circuit.

3. The surface cleaning device according to claim 1, wherein the analytical device is connected to the supply device.

4. The surface cleaning device according to claim 1, wherein the analytical device is connected to the return device.

5. The surface cleaning device according to claim 1, wherein the analytical device is connected to the tank.

6. The surface cleaning device according to claim 1, further comprising a valve that controls a flow rate of the cleaning medium through the analytical device.

7. The surface cleaning device according to claim 1, wherein the analytical device comprises a measuring device and an evaluation device connected to the measuring device.

8. The surface cleaning device according to claim 7, wherein the evaluation device comprises a computer that controls the measuring device.

9. The surface cleaning device according to claim 7, wherein the measuring device has a flow passage through which the cleaning medium is passed for performing a measurement.

10. The surface cleaning device according to claim 9, wherein the flow passage is arranged at least partially between a light source and a measuring unit of the measuring device.

11. The surface cleaning device according to claim 10, wherein the light source is a white light source.

12. The surface cleaning device according to claim 7, wherein the measuring device has an area sensor for simultaneously recording a plurality of measured values.

13. The surface cleaning device according to claim 12, wherein the area sensor is a sensor for recording a plurality of pixels.

14. The surface cleaning device according to claim 10, wherein the measuring device comprises a camera.

15. The surface cleaning device according to claim 7, wherein the evaluation device continuously computes, using measured values provided by the measuring device, the contamination of the cleaning medium based on at least one calibration value that is saved by software or hardware.

16. The surface cleaning device according to claim 1, wherein the analytical device is adapted to measure turbidity of the cleaning medium.

17. The surface cleaning device according to claim 1, wherein the analytical device is adapted to measure the contamination of the cleaning medium by spectral analysis.

18. The surface cleaning device according to claim 1, wherein the analytical device is adapted to perform image evaluation.

19. The surface cleaning device according to claim 1, wherein the analytical device is adapted to evaluate color distribution or brightness distribution.

20. The surface cleaning device according to claim 1, wherein the analytical device is adapted to evaluate color distribution and brightness distribution.

21. The surface cleaning device according to claim 1, wherein the analytical device is adapted to evaluate fluorescent goods to be cleaned.

22. The surface cleaning device according to claim 21, further comprising a device for illuminating the fluorescent goods.
